(19) United States
(12) Patent Application Publication
(10) Pub. No.: US 2018/0260567 A1
(43) Pub. Date: Sep. 13, 2018

(54) AUTOMATIC PROTECTION SYSTEM

(71) Applicant: GOT UR 6 TECHNOLOGIES LLC, Charleston, SC (US)

(72) Inventor: Clark S. Ullom, Charleston, SC (US)

(73) Assignee: GOT UR 6 TECHNOLOGIES LLC, Charleston, SC (US)

(21) Appl. No.: 15/920,044

(22) Filed: Mar. 13, 2018

Related U.S. Application Data
(60) Provisional application No. 62/470,547, filed on Mar. 13, 2017.

(51) Int. Cl. G06F 21/57; G06F 21/62

(52) U.S. Cl. CPC G06F 21/57; G06F 21/31; G06F 21/6245

(57) ABSTRACT

A method for protecting a user device or sensitive data contained on the user device may include providing a secondary device that communicates with the user device via a wireless connection and monitoring state information of the user device by the secondary device via the wireless connection. The method may further include determining, by the secondary device, that a first trigger event has occurred when the state information reaches a first threshold and executing a first security operation, by the secondary device or the user device, to protect the user device or the sensitive data contained on the user device. The trigger event lay correspond to, among other things, a distance between the user device and the secondary device, and the security operation may include, among other things, sending a notification to the user via the secondary device and displaying a notification on the user device.

### REFERENCE TO RELATED APPLICATION

This application claims priority to U.S. Provisional Patent Application No. 62/470,547 filed on Mar. 13, 2017, the entire contents of the provisional application being incorporated herein by reference.

### BACKGROUND

Many individuals store personal, confidential and/or private data (e.g. trade secrets, proprietary data, military secrets, personal information, credit card information, etc.) (hereinafter “sensitive data”) on an electronic device (e.g. cell phone, tablet, laptop, etc.) connectable to a network (e.g. the Internet, 4G Network, etc.). Unfortunately, electronic devices are often unintentionally misplaced, stolen, compromised or otherwise availed of circumstances which jeopardize the device and the sensitive data stored thereon. When this occurs, the, user of the electronic device may lose the device, the sensitive data and/or may have his/her sensitive data accessed by unintended third parties. What is needed is a way to automatically notify the user that the device is in danger of being lost or stolen, to automatically store the sensitive data on a server in the event of a loss/theft, and of to protect the sensitive data from being accessed by third parties.

### SUMMARY

According to an implementation described herein, a method for protecting a user device or sensitive data contained on the user device includes providing a secondary device that communicates with the user device via a wireless connection id monitoring state information of the user device by the secondary device via the wireless connection. The method further includes determining, by the secondary device or the user device or both, that a first trigger event has occurred when the state, information reaches a first threshold. The method further includes executing a first security operation, by, the secondary device or the user device, to protect the user device or the sensitive data contained on the user device when the first trigger event occurs. The method may further include determining that a second trigger event has occurred when the state information reaches a second threshold and executing a second security operation, by the secondary device or the user device, to protect the user device or the sensitive data contained on the user device when the second trigger event occurs. The method may further include determining that a third trigger event has occurred when the state information reaches a third threshold and executing a third security operation, by the secondary device or the user device, to protect the user device or the sensitive data contained on the user device when the third trigger event occurs. The method may further include determining that a fourth trigger event has occurred when the state information reaches a fourth threshold and executing, a fourth security operation, by the secondary device or the user device, to protect the user device or the sensitive data contained on the user device when the fourth trigger event occurs. The state information may include: a distance between the user device and the secondary device; an existence of the wireless connection; a location of the user device relative to a prohibited area; an amount of time the user device has been in the same location; a battery life of the user device; an incorrect password has been entered into the user device; an unsuccessful attempt to unlock the user device; an unrecognized device attempts to access the user device; or a combination of the foregoing. The distance between the user device and the secondary device may be determined geofencing. The distance between the user device and the secondary device may be determined by using beacons. The wireless connection may correspond to a WiFi connection or a Bluetooth connection. The first security operation may corresponds to one or more of: sending a notification to a user of the user device by the secondary device, locking the user device, or communicating the trigger event to a server device via a network by the secondary device or the user device. The notification may correspond to at least one of: a tactile notification, an audible notification, or a visual notification. The state information may include an amount of time from when a notification was sent to the user by the secondary device and the second threshold corresponds to a first time from when the notification was sent to the user by the secondary device. The first threshold may correspond to a distance between the user device and the secondary device. The second security operation may corresponds to one or more of locking the user device, prioritizing the sensitive data contained on the user device, uploading the sensitive data contained on the, user device to a server device via a network, encrypting the sensitive data, deleting the sensitive data, or overwriting the sensitive data. The method may further include monitoring state information of the user device by a server device that is connected to the user device via a network and determining, by the server device, that the first trigger event has occurred when the suite information reaches the first threshold. The method may further include executing a server security operation, by the server device, to protect the user device or the sensitive data contained on the user device. The server security operation may correspond to communicating with the user device to prompt the user device to execute instructions to upload the sensitive data to the server device via the network. The state information may include an amount of time from when a notification was sent to the user by the secondary device, the first threshold may corresponds to a distance between the user device and the secondary device, the second threshold may correspond to a first time threshold determined from when the notification was sent to the user by the secondary device, and the third threshold may correspond to a second time threshold, determined from when the notification was sent to the user by the secondary device, the second time threshold being greater than the first time threshold. The third security operation corresponds to one or more of prioritizing the sensitive data contained on the user device, uploading the sensitive data contained on the user device to a server device via a network, encrypting the sensitive data, deleting the sensitive data, or overwriting the sensitive data.

According to another implementation described herein, a method for protecting a user device or sensitive data contained on the user device includes providing a secondary device that communicates with the user device via a wireless connection and determining a distance between the secondary device and the user device. The method further includes monitoring the distance between the user device and the secondary device and determining, by the secondary device, that a first trigger event has occurred when the distance reaches a first threshold. The method further includes providing, via the secondary device, a notification to a user of the user device to protect the user device car the sensitive data contained on the user device. The method may further include determining that a second trigger event has occurred when the user has not responded icy the notification or has not dismissed the notification and locking the user device to protect the user device or the sensitive data contained on the user device. The method may further include providing a server device that communicates with the user device and the secondary device via a network to determine a first location of the user device and a second location of the secondary device and comparing the first location to the second location to determine the distance between the user device and the secondary device. The method may further include communicating by the server device via the network to the user device to lock the user device. The distance may be determined by the secondary device. The secondary device may determine the distance using beacon technology.

According to another implementation described herein, a secondary device for determining whether a distance between the secondary device and a user device has exceeded a threshold includes a communication interface that permits a wireless connection to be established with the user device and a processor that executes instructions to monitor the distance and to determine whether the distance has exceeded the threshold. The secondary device further includes a user interface that provides a notification to a user of the user device when the distance exceeds the threshold and a power source. The secondary device may further include a memory that includes the instructions executed by the processor. The instructions may be provided to the processor by a server device via a network. The notification may be one or more of an audible notification, a tactile notification, or a visual notification. The device may be made in the form of a bracelet, a watchband, a necklace, or another wearable article.

### BRIEF DESCRIPTION OF THE DRAWINGS

FIG. 1 illustrates a diagram of an example environment in which the systems and/or methods described herein may be implemented.

FIG. 2 illustrates a diagram of example components of the server of FIG. 1.

FIG. 3 illustrates a schematic view of an example user device.

FIG. 4 illustrates a diagram of example components of the user device of FIG. 3.

FIG. 5 illustrates an example environment in which the Systems and/or Methods described herein may be implemented.

FIG. 6 illustrates an example environment in which the Systems and/or Methods described herein may be implemented.

FIG. 7 illustrates a diagram of example components of the secondary device of FIG. 6.

### DETAILED DESCRIPTION

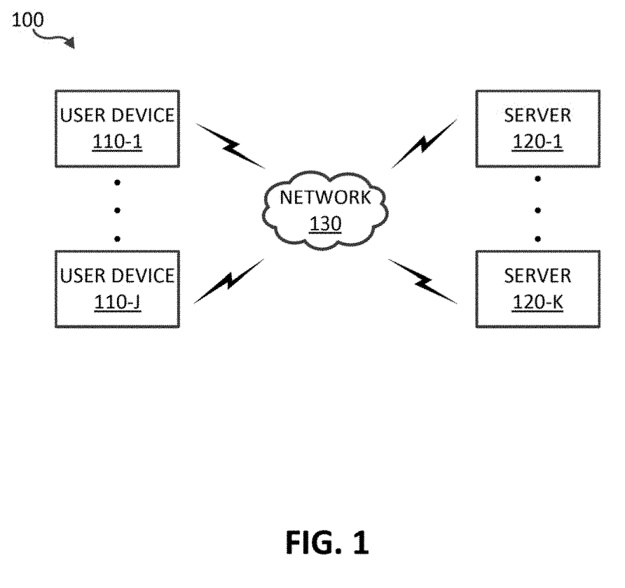

FIGS. 1-5 are attached hereto and incorporated herein by reference. The following detailed description refers to the accompanying FIGS. 1-5. The same reference numbers in different figures may identify the same or similar elements.

The systems, methods, technologies and/or techniques (hereinafter “systems and/or methods”) may provide systems and/or methods by which users may preserve and/or protect sensitive data stored on a user device. The systems and/or methods may include an application server that communicates, via a network, with a user device on which sensitive data is stored. The user device may execute a security application and/or logic (e.g., based on hardware, software, or a combination of hardware and software) (hereinafter “security application”) that enables the user device to determine when and a manner in which a security operation is to be performed on the sensitive data stored on the user device.

The systems and/or methods may enable the user device to execute the security application to detect when a security operation is to be performed based on the occurrence of one or more events (“trigger events”). A trigger event may, in a non-limiting example, occur when the user device is located in a prohibited geographic area; when a charge state of a battery is at a level that is less than a pre-determined charge threshold; when biometric data of a user does not comply with a biometric parameter; when the user device is being used during a prohibited time period (e.g., during non-business hours, weekends, holidays, etc.); when the user device cannot authenticate a user; when the user device detects a quantity of unsuccessful login events that is more than a login threshold; when an application server transmits an instruction to the user device to perform a security operation; when the user device is located at a distance from another device that is greater than a distance threshold; when the user device loses a connection with a secondary device; etc.

Upon detecting that the trigger event has occurred or is about to occur, the user device may perform a security operation to protect the device and/or the sensitive data that is stored in a memory associated with the user device, such as locking the user device, evaluating the data stored on the user device, identifying a portion of the data that constitutes sensitive data, classifying, one or more elements of the sensitive data based on the type of sensitive data; assigning a respective priority to the one or more classifications associated with the sensitive data; notifying the user of the user device that the trigger event has occurred or is about to occur; preparing sensitive data contained on the user device; uploading sensitive data contained on the user device, via network, to the application server and/or another device or server; deleting sensitive data contained on the user device; overwriting sensitive data contained on the user device; encrypting sensitive data contained on the user device; destroying sensitive data contained on the user device; and/or a combination of the foregoing.

In a on-limiting example, the user device may perform a security operation when a first trigger event occurs based on the user device detecting that the user device is approaching and/or has entered a prohibited geographic area. The prohibited geographic area may be programmed into the security application based on information specified by the user, an employer or an entity associated with the user device (e.g., when the user device is registered with the application server) and/or may he specified based on a communication from the application server and received by the user device.

Additionally, or alternatively, the user device may perform a security operation when a second trigger event occurs based on the user device detecting that the user device is approaching or has less than a battery life threshold. The battery life threshold may be programmed into the security application based on information specified by the user, an employer, or an entity associated with the user device and/or may be specified based on a communication, via the network, from the application server received by the user device.

Additionally, or alternatively, the user device may perform a security operation when a third trigger event occurs based on the user device detecting that the user device is approaching or has attained a communication threshold, which corresponds to an amount of time since the user device last communicated, via the network, with the application server and/or another device (e.g. another user device, a secondary device, etc.). Additionally, or alternatively, the communication threshold may be, associated with an amount of time that has passed since a notification was sent to the user (e.g. via another user device and/or a secondary device) informing the user of a trigger event without response from the user (e.g. via the user device, via another user device, via a secondary device, etc.) aborting a security operation. The application server communication threshold may be programmed into the security application based on information specified by the user, an employer, or an entity associated with the user device and/or may be specified based on a communication, via the network, from the application server received by the user device.

Additionally, or alternatively, the user device may perform a security operation when a fourth trigger event occurs based on the user device detecting that the user device cannot authenticate the user of the user device. Authentication of the user of a user device may be programmed into the security application based on information specified by the user, an employer, or an entity associated with the user device and/or may be specified based on a communication, via the network, from the application server received by the user device.

Upon detecting that the trigger event has occurred or is about to occur, the user device may execute a security operation to notify the user (e.g. via the user device, another user device, a secondary device, etc.) that the trigger event has occurred or is about to occur, which notification may or may not be received by the user. The notification may be any sort of communication directed to the user, including a tactile notification (e.g. a vibration, etc.), an auditory notification (e.g. a ring, a ping, an alarm, etc.), and/or a visual notification (e.g. a light, a message on a display, etc.). The notification may be programmed into the security application based on information specified by the user, an employer, or an entity associated with the user device and/or may be specified based on a communication, via the network, from the application server received by the, user device. Upon receiving the notification, the user may search for a missing user device, abort all farther security operations, prevent the trigger event from occurring, and/or may cause additional security operations to be performed.

Additionally, or alternatively, upon detecting that the trigger event has occurred or is about to occur, the user device may execute a security operation to lock the user device. Locking the user device may include prohibiting the user from accessing the device without provide a password or other authentication information (e.g. thumbprint, facial scan, retinal scan, etc.). Instructions to lock the user device may be programmed into the user device and/or the security application based on information specified by the user, an employer, or an entity associated with the user device and/or may be specified based on a communication, via the network, from the application server received by the user device.

Additionally, or alternatively, upon detecting that the trigger event has occurred or is about to occur, the user device may execute a security operation to prepare sensitive data contained on the user device. Preparing sensitive data may include identifying and prioritizing the sensitive data based on a level of security (e.g. top secret, secret, confidential, etc.). The user device and/or the application server may analyze the data stored on the user device to determine what portion of the data stored on the user device qualifies as sensitive data. For example, sensitive data may he stored on memory associated with the user device in a way that designates it as sensitive data to the user device and/or the application server, such as residing in a folder within the memory used for storing sensitive data. Additionally, or alternatively, specific data file types may identify sensitive data e.g. .xls files, etc.). The user device and/or the application server may further analyze sensitive data to determine a level of priority to assign to the data. For example, top secret sensitive data may be stored on memory associated with the user device in a way that designates its priority, such as having a file name containing letters that identify its priority (e.g. “TS” included in the name for top secret, etc.). The priority assigned to the sensitive data may determine the order in which security operations (e.g. encrypting, deleting, transferring, etc.) are performed on the sensitive data (i.e. top secret is first, secret is second, etc.) Preparing the sensitive data may also include packetizing the sensitive data for future transfer. Preparing the sensitive data may also include encrypting the sensitive data. Instructions to prepare the sensitive data may be programmed into the security application based on information specified by the user, an employer, or an entity associated with the user device and/or tray be specified based on a communication, via the network, from the application server received by the user device.

Additionally, or alternatively, upon detecting that the trigger event has occurred or is about to occur, the user device may execute a security operation to upload sensitive data contained on the user device to the application server, or another server or device, via the network. Uploading sensitive data may include uploading the sensitive data from the user device to the application server via a secure connection (e.g. HTTPS virtual private network, etc.) of the network. Uploading, sensitive data may also include using spread spectrum technology to upload sensitive data, via the network, from the user device to the application server. Uploading sensitive data may also include using divided session-layer technology to upload sensitive data, via the network, from the user device to the application server. Instructions to upload the sensitive data may be programmed into the security application based on information specified by the user, an employer, or an entity associated with the user device and/or may be specified based on a communication, via the network, from the application server received by the user device.

In another non-limiting example, a first user device containing sensitive data may perform a security operation when a first trigger event occurs or is about to occur based on the first user device detecting that the first user device is approaching and/or has attained a first distance threshold, which corresponds to a distance between the first user device and a second user device connected to the first user device via the network. The first distance threshold may be programmed into the security application based on information specified by the user, an employer, or an entity associated with the user device and/or may be specified based on a communication, via the network, from the application server received by the user device.

Upon detecting that the first trigger event has occurred or is about to occur, the first user device and second user device may execute a security operation to notify the user, via the first user device and/or the second user device, that the trigger event has occurred or is about to occur. The notification may be a tactile, auditory and/or visual notification. The notification may be programmed into the security application based on information specified by the user, an employer, or an entity associated with the user device and/or may be specified based on a communication, via the network, from the application server received by the user device.

Additionally, or alternatively, the first user device may perform a security operation when a second trigger event occurs based on the first user device detecting that the first user device is approaching and/or has attained a second distance threshold, which corresponds to a distance between the first user device and a second user device that is greater than the first distance threshold. The second distance threshold may be programmed into the security application based on information specified by the user, an employer, or an entity associated with the user device and/or may be specified based on a communication, via the network, from the application server received by the user device.

Upon detecting that the second trigger event has occurred or is about to occur, the first user device may execute a security operation to upload sensitive data contained on the first user device to the second user device via the network. Instructions to upload the sensitive data may be programmed into the security application based on information specified by the user, an employer, or an entity associated with the user device and/or may be specified based on a communication, via the network, from the application server received by the user device.

In another non-limiting example, an application server connected to a user device containing sensitive data may transmit instructions to the user device to perform a security operation when the application server determines that a trigger event has occurred or is about to occur when the application server determines, based upon an analysis of state information, as hereinafter defined, that a first user device has violated or is about to violate a state threshold. Application server may communicate with the user device to determine state information, such as the location of the user device; how the location of the user device has changed over time; the battery life of the user device; the distance between the user device and another device; loss of a wireless connection between the user device and another device, the number of consecutive unsuccessful attempts to unlock the user device; connection of the user device to another unrecognized device; the amount of time elapsed since the user device last communicated with an application server, etc. (hereinafter “State Information”). The application server may monitor state information to determine whether the user device has violated or is about to violate a state threshold. The state threshold may be programmed into the security application based on information specified by the user, an employer, or an entity associated with the user device and/or may be specified based on a communication, via the network, from the application server received by the user device.

Upon detecting that the second trigger event has occurred or is about to occur, the application server may communicate with the first user device to cause the first user device to execute a security operation to upload sensitive data contained on the first user device to the application server via the network. Additionally, the application server may communicate with another device (e.g. another user device, a secondary device, etc.) associated with the user to notify the user of the security operation and/or to permit the user to authorize or abort the security operation. Instructions to upload the sensitive data may be programmed into the security application based on information specified by the user, an employer, or an entity associated with the user device and/or may be specified based on a communication, via the network, from the application server received by the user device.

FIG. 1 is a diagram of an example Environment 100 in which the Systems and/or Methods described herein may be implemented. As shown in FIG. 1, Environment 100 may include a group of user devices 110-1, 110-2, . . . , 110-J (collectively referred to herein as “user devices 110” and individually as “user device 110”) (where J≥1) and, a group of application servers 120-1, 120-2, . . . , 120-K (collectively referred to as “application servers 120” or individually as “application server 120”) (where K≥1) that are interconnected by a network 130. The number of devices and/or networks illustrated in FIG. 1 is provided for explanatory purposes only. In practice, there may be additional networks and/or devices, fewer networks and/or devices, different networks and/or devices, and/or differently arranged networks and/or devices that illustrated in FIG. 1. For example, Environment 100 may additionally, or alternatively, include one or more databases configured to store data. The one or more database may be associated with one or more application servers 120 and/or one or more user devices 110 to store data sent and/or received by server 120 and/or user device 110. Each user device 110 and/or application server 120 may be associated with one or more database—

Also, in some implementations, one or more of the components of Environment 100 may perform one or more functions described as being performed by another one or more of the components of Environment 100. Components of Environment 100 may interconnect via wired connections, wireless connections, or a combination of wired and wireless connections.

User device 110 may include any computation or communication device, such as a wireless mobile communication device, that is capable of communicating with network 130 and/or another device, directly or indirectly. For example, user device 110 may include a personal communications system (PCS) terminal (e.g., such as a smart phone that may include data processing and data communications capabilities), a personal digital assistant (PDA) (e.g., that can include a pager, Internet/intranet access, etc.), a laptop computer, a tablet computer, a personal computer, a camera, a personal gaming system, a smart watch, wearable technology, or another type of computation or communication device. Additionally, or alternatively, user device 110 may include logic, such as one or more processing or storage devices, that can be used to perform processing activities on behalf of a user.

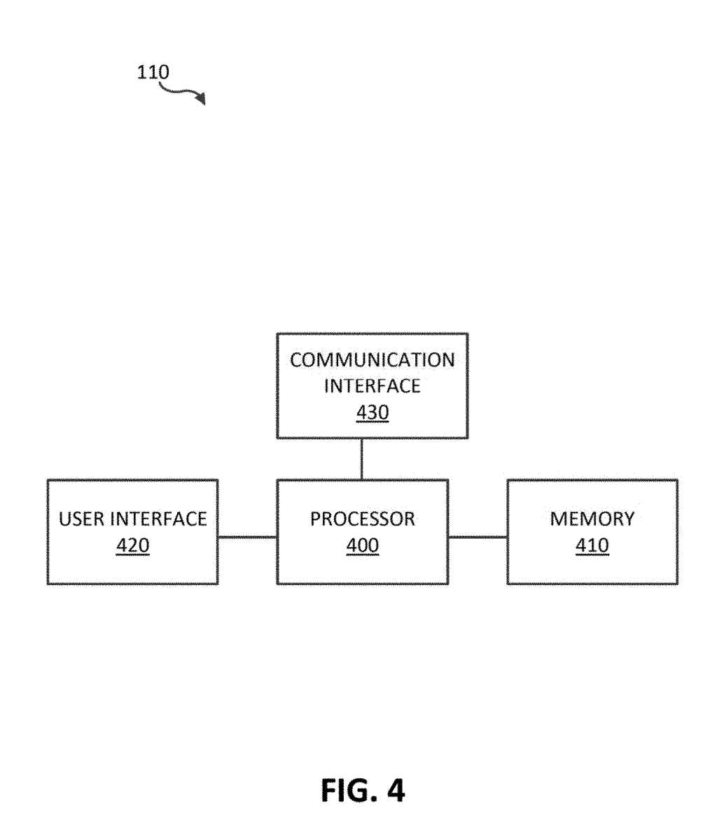

User device 110 may be configured to perform communication operations by sending data to and/or receiving data from another device and/or server 120. Data may refer to any type of machine-readable information having substantially any format that may be adapted for use in one or more networks and/or with one or more components. Data may include digital information or analog information. Data may further be packetized and/or non-packetized. User device 110 may include logic for performing computations on user device 110 and may include the components illustrated in FIG. 4 in an example implementation. Such components may execute one or more instructions to perform functions as described herein.

User device 110 may include an input device for the input of information, as further described herein, and/or a display device to display information, as further described herein. Additionally, or alternatively, the user device may include an input and/or output mechanism that may allow for the transfer of data, including sensitive data, from/to the user device from/to a server and/or another user device. In one non-limiting implementation,the user device may not be in persistent communication and/or connection with network but may, when accessed and/or communicated with, communicate with a server and/or another user device

Server 120 may include one or more server devices, or other types of computation or communication devices, that are configured to gather, process, search, store, and/or provide information in a manner described herein. Server 120 may be configured to communicate via network 130. For example, server 120 may include application server 120-1 and/or may provide a user interface (“UI”), website, and/or application that can be displayed, downloaded, and/or installed on user device 110 and/or other servers to permit user device 110 and/or other servers 120 to perform operations and/or display information as described herein and/or Appendix A. Server 120 may be configured to communicate with network 130 and/or other servers 120 and/or user devices 110 via network 130 to perform operations such as, for example, those described herein and in the appendixes. Sever 120 may also, or alternatively, be configured to act as a web server 120 or some other type of server 120 that hosts one or more website and/or application that may be accessed by user device 110 and/or another server 120.

Server 120 may be associated, via the network. 130, with one or more user devices 110. Additionally, or alternatively, a unique identifier may allow for confirmation of a user device 110, ownership of the user device 110, sensitive data stored on the user device 110, etc. Server 120 may include logic, such as one or more processing or storage devices, that may be used to perform processing activities on behalf of a user. Additionally, or alternatively, the user device 110 may include logic, such as one or more processing or storage devices, that may be used to perform processing activities on behalf of a user. Additionally, or alternatively, server 120 may transfer, via a network 130, instructions to the user device 110 to be executed on the user device 110. Additionally, or alternatively, user device 110 may transfer, via a network 130, instructions to the server 120 to be executed on the server 120.

Network 130 may include one or more wired and/or wireless networks. For example, network 130 may include a wide area network (WAN) a metropolitan network (MAN), a telephone network (e.g. the Public Switched Telephone (PSTN)), an ad hoc network, an intranet, the Internet, a fiber optic based network, and/or a combination of these or other types of networks. Additionally, or alternatively, network 130 may include a cellular network, a public land mobile network (PLMN), a second generation (2G) network, a third generation (3G) network, a fourth generation (4G) network (e.g., a long term evolution (LTE) network), a fifth generation (5G) network, and/or another network.

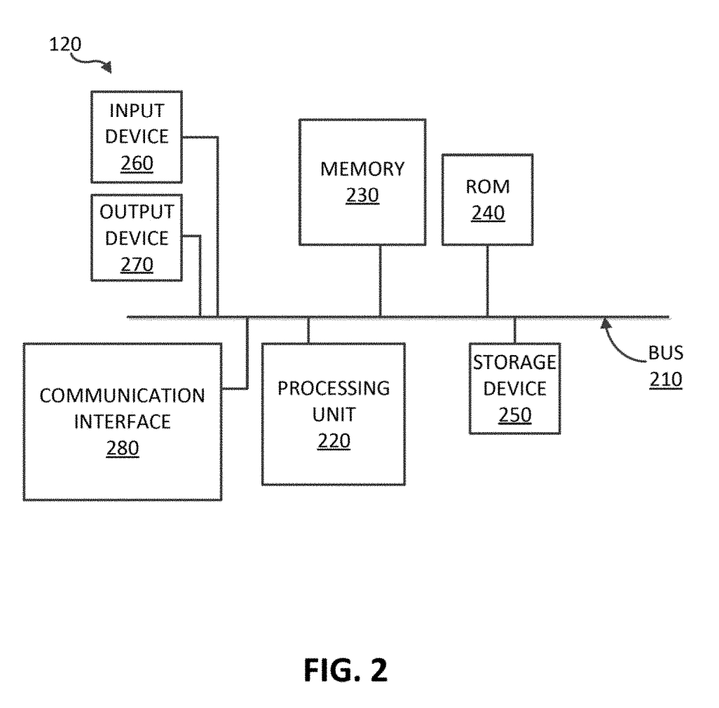

Referring now to FIG. 2, server 120 may include a collection of components, such as a bus 210, a processing unit 220, a memory 230, a read-only memory (“ROM”) 240, a storage device 250, an input device 260, an output device 270, and/or a communication interface 280. Bus 210 may include a path that permits communication among the components of server 120.

Although FIG. 2 depicts example components of server 120, in other implementations, server 120 may include fewer components, additional components, different components, or differently arranged components than illustrated in FIG. 2. For example, server 120 may include a user device. In still other implementations, one or more components of server 120 may perform one or more tasks described as being performed by one or more other components of server 120.

Processing unit 220 may include a processor, multiple processors, microprocessors, or other types of processing logic that may interpret, execute, and/or otherwise process information and/or data contained in, for example, the storage device 250 and/or memory 230. The information may include computer-executable instructions and/or data that may implement one or more embodiments of the Systems and/or Methods. Processing, unit 220 may comprise a variety of hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. Processing unit 220 may comprise a single core or multiple cores. Moreover, processing unit 220 may comprise a system-on-chip (SoC) or system-in-package (SiP). Additionally, or alternatively, processing unit 220 (and/or another component of server 120) may be configured to generate and/or update keys (e.g., encryption keys, rotating keys, etc.).

Memory 230 may include a random access memory (RAM) or another type of dynamic storage device that may Store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive. In some implementations, memory 230 or storage device 250 may also be implemented as solid state memory, such as flash-based memory.

Input device 260 may include a mechanism that permits an operator to input information to server 120, such as a keyboard, a mouse, a pen, a single or multi-point touch interface, an accelerometer, a gyroscope, a microphone, voice recognition and/or biometric mechanisms, etc. Output device 270 may include a mechanism that outputs information to the operator, including a display, a printer, a speaker, etc. In the case of a display, the display may be a touch screen display that acts as both an input and an output device. Input device 260 and/or output device 270 may be haptic type devices, such as joysticks or other devices based on touch.

Communication interface 280 may include any transceiver-like mechanism that enables server 120 to communicate with other devices and/or systems. For example, communication interface 280 may include mechanisms for communicating with another device or system via a network, e.g., a network interface card.

Server 120 may perform certain operations in response to processing unit 220 executing software instructions contained in a computer-readable medium, such, as main memory 230. For instance, server 120 may implement an application by executing software instructions from main memory 230. A computer-readable medium may be defined as a non-transitory memory device, where the memory device may include a number of physically, possibly distributed, memory devices. The software instructions may be read into main memory 230 from another computer-readable medium, such as storage device 250, or from another device via communication interface 280. The software instructions contained in main memory 230 may cause processing unit 220 to perform processes that will be described later. Alternatively, hardwired circuitry may be used in place of, or in, combination with, software instructions to implement processes described herein. Thus, implementations described herein are not limited to any specific combination of hardware circuitry and software.

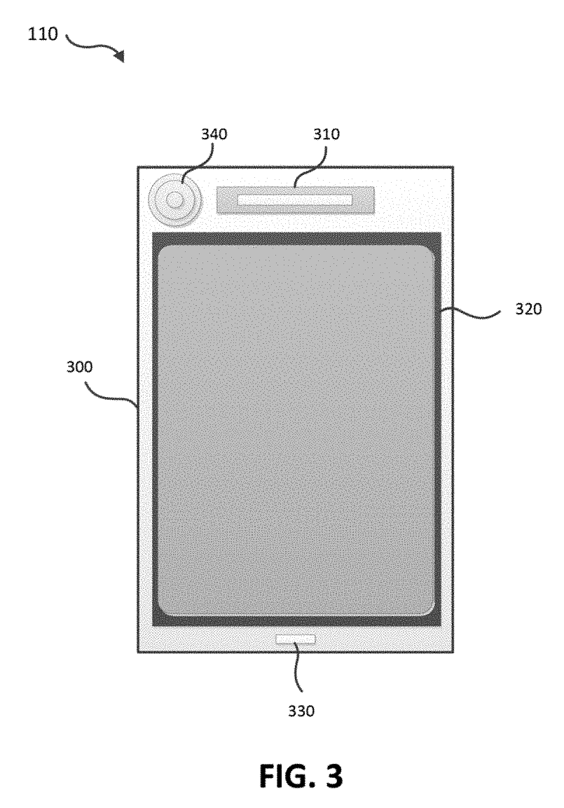

FIG. 3 is a diagram of an example user device 110. As shown in FIG. 3, user device 110 may include a housing 300, a speaker 310, a display 320, a microphone 330. Housing 300 may include a chassis via which some or all of the components of user device 110 are mechanically secured and/or covered. Speaker 310 may include a component to receive input electrical signals from user device 110 and to transmit audio output signals, which communicates audible information to a user of user device 110.

Although FIG. 3 depicts example components of user device 110, in other implementations, user device 110 may include fewer components, additional components, different components, or differently arranged components than illustrated in FIG. 3. For example, user device 110 may include a keyboard, a keypad, and/or other input components. In other implementations, one or more components of user device 110 may perform one or more tasks described as being performed by one or more other components of user device 110. In still other implementations, user device 110 may include and/or be configured to be in wired and/or wireless communication with server 120 and/or another user device 110, such that user device 110 may send and/or receive data to and/or from server 120 and/or another user device 110.

Display 320 may include a component to receive input electrical signals and present a visual output in the form of text, images, videos and/or combinations of text, images, and/or videos which communicate visual information to the user of user device 110. In one implementation, display 320 may display text input into user device 110, text, images, and/or video received from another device and/or server 120, and/or information regarding incoming or outgoing calls or text messages, emails, media, games, phone books, address books, the current time, etc.

Display 320 may be a touch screen that presents one or more images that corresponds to control buttons. The one or more images may accept, as input, mechanical pressure from the user (e.g., when the user presses or touches an image corresponding to a control button or combinations of control buttons) and display 320 may send electrical signals to a processor associated with user device 110 that may cause user device 110 to perform one or more operations. For example, the control buttons may be used to cause user device 110 to transmit information. Display 320 may present one or more other images associated with a keypad that, in one example, corresponds to a standard telephone keypad or another arrangement of keys. Microphone 330 may include a component to receive audible information from the user and send, as output, an electrical signal that may be stored by practitioner device 110, transmitted to another user device 110 and/or server 120, or cause the user device 110 to perform one or more operations.

FIG. 4 is a diagram of example components of user device 110. As shown in FIG. 4, user device 110 may include a processor 400, a memory 410, a user interface 420, and/or a communication interface 430. Although FIG. 4 shows example components of user device 110, in other implementations, user device 110 may include fewer components, additional components, different components, or differently arranged components than depicted in FIG. 4. In still other implementations, one or more components of user device 110 may perform one or more tasks described as being performed by one or more other components of user device 110.

Processor 400 may include a processor, a microprocessor, an ASIC, a FPGA, or the like. Processor 400 may control operation of user device 110 and its components. In one implementation, processor 400 may control operation of components of user device 110 in a manner similar to that described herein. Memory 410 may include a RAM, a ROM, and/or another type of memory to store data and/or instructions that may be used by processor 400.

User interface 420 may include mechanisms for inputting information to user device 110 and/or for outputting information from user device 110. Examples of input and output mechanisms might include buttons (e.g., control buttons, keys of keypad, a keyboard, a joystick, etc.); a touch screen interface to permit data and control commands to be input into user device 110 via display 320; a speaker (e.g., speaker 310) to receive electrical signals and output audio signals; a microphone (e.g., microphone 330) to receive audio signals and output electrical signals; a display (e.g., display 320) to output visual information (e.g., user interfaces, web pages, etc.); a vibrator to cause practitioner device 110 to vibrate; and/or a camera to receive video and/or images.

Communication interface 430 may include a transceiver to perform functions of both a transmitter and a receiver of wireless communications, wired communications, or a combination of wireless and wired communications, including communications to/from server 120 and another user device 110. Wired and wireless communications may be sent/received using antennas, receivers, and other equipment known in the art.

User device 110 may perform certain operations described herein in response to processor 400 executing software instructions of an application contained in a computer-readable medium, such as memory 410. The software instructions may be read into memory 410 from another computer-readable medium or from another device via communication interface 430. The software instructions contained in memory 410 may cause processor 400 to perform processes that will be described later. Alternatively, hardwired circuitry may be used in place of or in combination with software instructions to implement processes described herein. Thus, implementations described herein are not limited to any specific combination of hardware circuitry and software.

Memory 410 may Store information and instructions for execution by processor sensitive data may be read into memory 410 from another computer-readable medium, from another device and/or server 120 via communication interface 430, and/or from user interface 420.

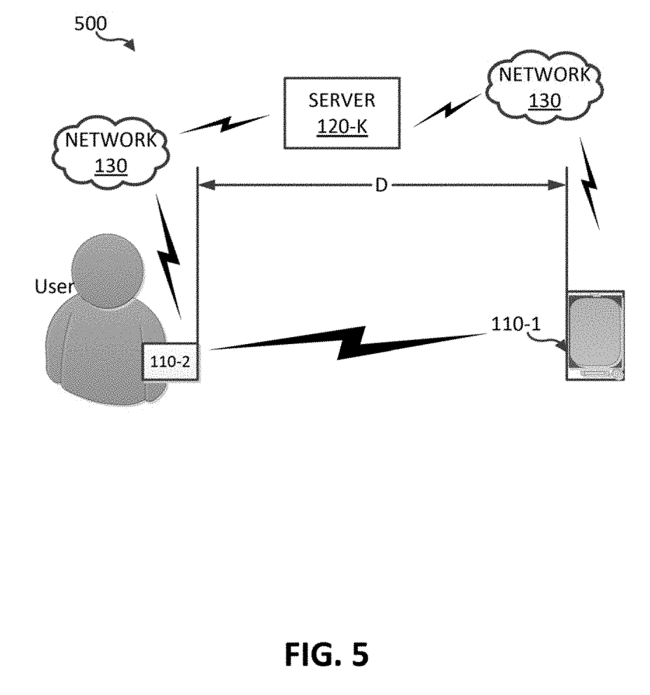

FIG. 5 illustrates an example environment in which the Systems and/or Methods described herein may be implemented. As shown in FIG. 5, Environment 500 may include a first user device 110-1, a second user device 110-2 and an application server 120-1 (not shown) that are interconnected by a network 130 (not shown). Environment 500 may also define a distance D between first user device 110-1 and second user device 110-2. The number of devices and/or networks illustrated in FIG. 5 is provided for explanatory purposes only, in practice, there may be additional networks and/or devices, fewer networks and/or devices, different networks and/or devices, and/or differently arranged networks and/or devices that illustrated in FIG. 5.

First user device 110-1 and/or second user device 110-2 may contain hardware (e.g. antenna assemblies, communication interfaces, processors, etc.), computer-executable instructions and/or a combination of hardware and computer-executable instructions which may provide first user device 110-2, second user device 110-2 and/or application server 120-1 with: (1) the location of first user device 110-1 and/or second user device 110-2; (2) how the location of the first user device 110-1 and/or second user device 110-2 has changed over time; (3) the battery life of the first user device 110-1 and/or second user device 110-2; (4) the distance between first user device 110-1 and second user device 110-2; (6) the existence of a wireless connection between first user device 110-1 and second user device 110-2; (6) the number of consecutive unsuccessful attempts to unlock first user device 110-1 and/or second user device 110-2; (7) connection of first user device 110-1 and/or second user device 110-2 to an unrecognized device; (8) the amount of time elapsed since first user device 110-1 and/or second user device 110-2 last communicated with application server 120-1; and/or (9) any other parameter regarding first user device 110-1 and/or second user device 110-2 (hereinafter collectively “State Information”).

First user device 110-1 and/or second user device 110-2 may contain sensitive data read into memory and instructions read into memory executable to prepare sensitive data based upon parameters provided to first user device 110-1 and/or second user device 110-2 by the user, by application server 120-1, by first riser device 110-1 and/or second user device 110-2 and/or by another device and/or server. Preparing sensitive data may include identifying sensitive data contained on a user device 110, prioritizing sensitive data contained on a user device (i.e. top secret, secret, confidential, proprietary, etc.), packetizing sensitive data contained on a user device, and otherwise preparing sensitive data for transfer, deletion, storage, etc.

First user device 110-1 may obtain its position (i.e. using, for instance GPS signals or cell-tower triangulation, etc.) and may obtain the position of second user device 110-2 from second user device 110-2, and/or from application server 120-1. Additionally, or alternatively, first user device 110-1 may share a local wireless connection (e.g. Bluetooth, WiFi, etc.), the existence of which may provide that the distance between first user device 110-1 and second user device 110-2 is not more than a threshold distance. For example, the local wireless connection may disconnect once the threshold distance is exceeded. Alternatively, the local wireless connection may provide that the user device and/or the other device may serve as beacons (e.g. like Bluetooth beacons) that may be used to estimate the distance between the devices.

With reference to FIG. 5, first user device 110-1, second user device 110-2 and/or server device 120 may execute instructions to estimate the distance D between first 110-1 and second user device 110-2 based upon the location of the two devices and/or the wireless connection between the two devices. The distance may be determined by, for instance, using the GPS position of each device, which is provided via server device 120, and the distance D is determined based upon comparing the GPS positions. Additionally, or alternatively, geofencing using GPS coordinates may be used to determine whether first user device 110-1 is within a boundary (i.e. the distance D) of the second user device 110-2. Additionally, or alternatively, RFID or other known technologies may be used instead of, or in addition to, GPS position to determine boundaries, relative distances, etc. Additionally, or alternatively, distance D may, as described herein, be determined via a Bluetooth connection (e.g. using Bluetooth beacons, etc.). First user device 110-1, second user device 110-2 and/or application server 120-1 may provide that when the distance :D reaches a threshold, a trigger event has occurred.

Additionally, or alternatively, the first user device 110-1, second user device 110-2 and/or application server 120-1 may identify other trigger events. For example, trigger event may occur when the location of first user device 110-1 and/or second user device 110-2 is determined to be within a prohibited area (e.g. a competitor's office, a foreign country, etc.) Trigger event may also, or alternatively, occur when first user device 110-1 and/or second user device 110-2 is not located within an acceptable area (e.g. a building, a city, a region, a country, etc.). Trigger event may also, or alternatively, occur when the application server 120-1 cannot verify the location of first user device 110-1 and/or second user device 110-2. Trigger event may also, or alternatively, occur, when the location of first user device 110-1 and/or second user device 110-2 has not changed over time. Trigger event may also, or alternatively, occur when the location of the first user device 110-1 and/or the second user device 110-2 has changed dramatically over a period of time (e.g. from the United States to Africa within an hour, etc.).

Trigger event may also occur when the battery life of the first user device 110-1 and/or second user device 110-2 falls below a certain threshold (e.g. 10%, 20 minutes of operating life, etc.). Trigger event may also occur when the first user device 110-1 loses its personal area network connection Bluetooth connection, etc.) with second user device 110-2. Trigger event may also occur when access to first user device 110-1 and/or second user device 110-2 has been denied (e.g. incorrect password attempts, inaccurate thumbprint, incorrect secure connection attempts, etc.) more than a threshold number of times. Trigger event may also occur when an unrecognized device attempts to access first user device 110-1 and/or second user device 110-2. Trigger event may also occur when first user device 110-1 and/or second user device 110-2 fails to communicate, via network, with application server 120-1 for a threshold period of time. Trigger event may also, or alternatively, occur when a combination of two or more of the foregoing events occurs. Trigger event is not limited to the foregoing example events. Trigger event may be based upon the occurrence of any event or series of events determinable by a user device 110 and/or server 120, including, but not limited to, events based upon conditions of user device 110 and/or analysis of state information and/or external conditions (e.g. declaration of war in the geographic area within which user device 110 is located, etc). Trigger event may be customizable by user 110, such as via user interface, or a third party via server 120, such as through a server user interface.

Upon the occurrence of trigger event, first user device 110-1 and/or second user device 110-2 may execute a security operation, as described herein, to protect sensitive data stored on a first user device 110-1 and/or a second user device 110-2. With reference to FIG. 5, trigger event may correspond to when distance D reaches a threshold, which may be determined by first user device 110-1, second user device 110-2 and/or application server 120-1 and/or by losing a local wireless connection between first user device 110-1 and second user device 110-2. Security operation may be executed on first user device 110-1 when the first user device 110-1 executes instructions contained on the first user device 110-1 and/or transmitted, via network 130, to first user device 110-1 from application server 120-1. Security operation may be executed on second user device 110-2 when the second user device 110-2 executes instructions contained on the second user device 110-2 and/or transmitted, via network 130, to second user device 110-2 from application server 120-1. Security operation may be executed on application server 120-1 when the application server 120-1 executes instructions contained on application server 120-1.

Security operation may include, for instance, providing a notification (e.g. an audible notification, a visual notification, a tactile notification, etc.) of a trigger event on first user device 110-1 and/or second user device 110-2. First trigger event may also include sending a notification of the trigger event to server device 120, which may prompt server device to perform additional security operations (e.g. communicate with user device 110 to execute instructions to upload sensitive data to the server device 120, delete the sensitive data on the user device 110, overwrite the sensitive data on the user device 110, etc.) described herein, either then or upon the occurrence of subsequent trigger events. Additionally, or alternatively, security operation may include locking the first user device 110-1. Additionally, or alternatively, security operation may include prioritizing sensitive data contained on first user device 110-1 (e.g. top secret, secret, confidential, etc.) based upon instructions contained on the user device 110 the server 120 and/or from the user. Additionally, or alternatively, security operation may include uploading sensitive data contained on first user device 110-1, via a network 130, to application server 120-1 and/or another user device (e.g. cloud-based storage, etc.). Sensitive data may be encrypted before it is uploaded. Additionally, or alternatively, security operations may include uploading sensitive data to application server 120-1, and/or another server and/or device, via a secure network (e.g. wired equivalent privacy, Wi-Fi protected access, HTTPS, virtual private network, etc.) and/or using spread spectrum technology to transfer sensitive data and/or using divided session-layer technology to upload sensitive data. Sensitive data may be uploaded in a specific sequence based upon the level of priority assigned to the data (e.g. top secret uploaded first, secret uploaded second, etc.). Additionally, or alternatively, security operations may include deleting sensitive data contained on first user device 110-1, overwriting sensitive data contained on first user device 110-1, encrypting Sensitive data contained on first user device 110-1 and/or destroying sensitive data contained on first user device 110-1. Additionally, or alternatively, security operation may include deleting, overwriting, encrypting and/or destroying sensitive data contained on first user device 110-1 in a specific sequence based upon a priority assigned to the data, and/or a combination of the foregoing.

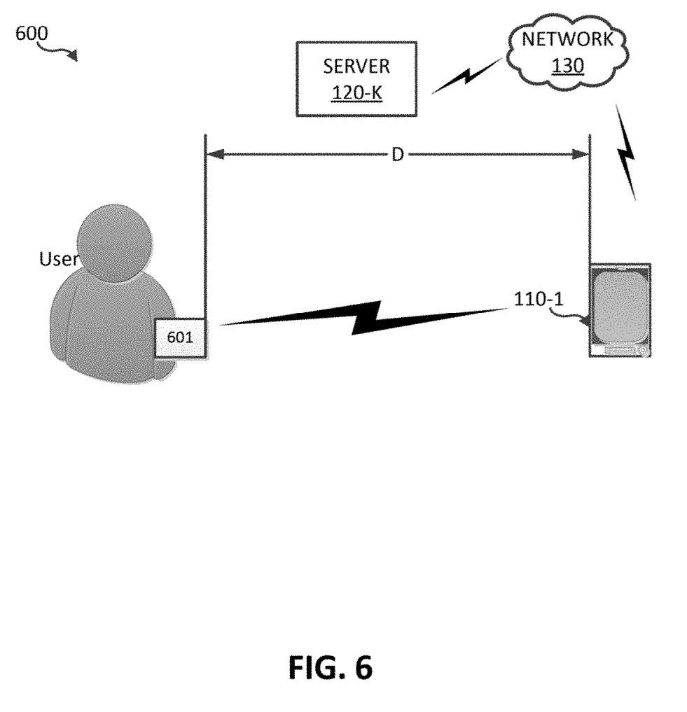

FIG. 6 illustrates an example environment in which the Systems and/or Methods described herein may be implemented. FIG. 6 may correspond to the example embodiment of FIG. 5 except that, instead of the second user device 110-2 of FIG. 5, environment 600 may include a secondary device 601 and may define a distance D2 between first user device 110-1 and secondary device 600. The number of devices and/or network's illustrated in FIG. 6 is provided for explanatory purposes only. In practice, there may be additional networks and/or devices, fewer networks and/or devices, different networks and/or devices, and/or differently arranged networks and/or devices that illustrated in FIG. 6.

Secondary device 601 may be an electronic device that may communicate with first user device 110-1 via a personal area network (e.g. Bluetooth, wireless USB, etc.). Secondary device 601 may include less functionality than second user device 110-2 as further explained with regard to FIG. 6. For example, secondary device 601 may include a wearable smart device (e.g. smart watch, etc.) or other device that may be connectable to first user device 110-1 and may provide notification to a user. Additionally, or alternatively, secondary device 601 may obtain its position (e.g. by GPS signals, triangulation, etc.) and may provide this position to first user device 110-1 and/or application server 120-1. Additionally, or alternatively, secondary device may monitor biometric data of a user (e.g. heart rate, blood pressure, etc.) and may communicate biometric information to first user device 110-1 and/or application server 120-1 via a network.

First user device 110-1, secondary device 601 and/or application server 120-1 may execute instructions to determine that the distance D2 between the first user device 110-2 and secondary device 601 is above and/or below a threshold. Additionally, or alternatively secondary device 601 may determine that the distance D2 exceeds a threshold when, for instance, the local network connecting first user device 110-1 and secondary device 601 is lost, provides that first user device 110-1 and secondary device 601 are no longer within the same geofence or region, etc. First user device 110-1, secondary device 601 and/or application server 120-1 may determine that when the distance D2 reaches a threshold, a trigger event has occurred or is about to occur. Additionally, or alternatively, first user device 110-1 and/or application server 120-1 may determine other trigger events. For example, biometric data of a user may be monitored by secondary device 601 and compared (e.g., by secondary device 601, first user device 110-1 and/or application server 120-1) to an acceptable range of biometric parameters (e.g. max heart rate, acceptable blood pressure range, etc.) stored on the memory of first user device 110-1, secondary device 601 and/or application server 120-1 to determine whether the biometric data falls within the acceptable range of biometric parameters. If biometric does not fall within the acceptable range of biometric parameters, first user device 110-1, secondary device 601 and/or application server 120-1 may determine that a trigger event has occurred or is about to occur. Additionally, or alternatively, first user device 110-1, secondary device 601 and/or application server 120-1 may determine that a trigger event has occurred or is about to occur when first user device 110-1 loses its connection with, or fails to communicate with, secondary device 601 via personal area network. Upon the occurrence of trigger event, first user device 110-1 and/or secondary device 601 may execute a security operation, as described herein, to protect the first user device 110-1 and/or sensitive data stored on a first user device 110-1.

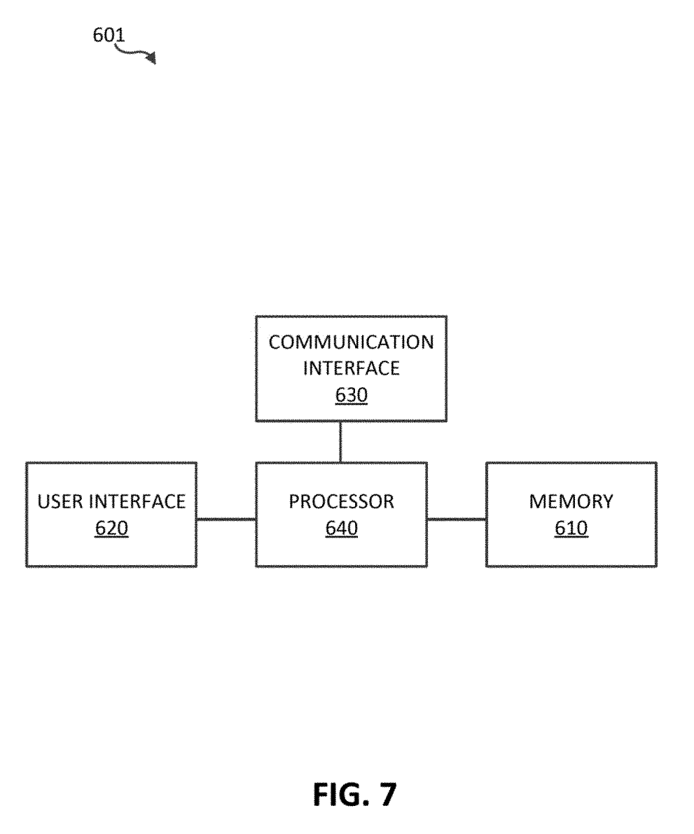

FIG. 7 illustrates a diagram of example components of secondary device 601 of FIG. 6. The components of secondary device 601 may include components that function the same as, or similar to, the similarly named components of user device 110 depicted in FIG. 4 except as described further below, and may include a processor 640, a memory 610, a user interface 620, and/or a communication interface 630. Although FIG. 7 shows example components of secondary device 601, in other implementations, secondary device 601 may include fewer components, additional components, different components, or differently arranged components than depicted in FIG. 6. In still other implementations, one, or more components of secondary device 601 may perform one or more tasks described as being performed by one or more other components of secondary device 601.

User interface 620 may be more limited than user interface 420 and may include, for instance, only mechanisms for outputting notifications from secondary device 601, such as a speaker or buzzer for audible notifications, a vibration generator for tactile notifications, a light or display for visual notifications, etc. Additionally, or alternatively, user interface 620 may include input mechanisms such as, for instance, sensors for measuring biometric data, etc. Other examples of input mechanisms are provided along with the description of user interface 420 above.

Communication interface 630 may include a transceiver to perform functions of both a transmitter and a receiver of wireless communications, wired communications, or a combination of wireless and wired communications, including communications to/from server 120 and another user device 110. Communication interface 630 may be limited to communicating on wireless local networks (e.g. Bluetooth, etc.) with first user device 110-1 and/or may also communicate with first user device 110-1 and/or application server 120-1 via the network 130.

In one embodiment, secondary device 601 may be a compact device that could be integrated into a watch or watch band or other wearable article (e,g, a necklace, a bracelet, etc.) and that includes a user interface 630 that is limited to a vibration generator, a communication interface 630 that is limited to a Bluetooth wireless connection equipment (i.e. to connect with user device 110), and a processor 640 that executes simple instructions stored on memory 610 to monitor the distance between secondary device 601 and user device 110. In this embodiment, the secondary device 601 may monitor the distance between secondary device 601 and user device 110 using, for instance, Bluetooth beacons (hardware transmitters using low energy Bluetooth technology). Bluetooth beacons allow the secondary device 601 to determine the distance and, because this is a low energy technology, allow the secondary device to include a relatively small power source (e.g. a battery). Alternatives to Bluetooth beacons can also be used, such as the iBeacon protocol by Apple, Inc., which uses similar beacon technology to the technology used in a low energy Bluetooth network. Additionally, or alternatively, the secondary device may include additional features, such as the ability to communicate via additional wireless connections, which may allow the secondary device to communicate with, for example, server device 120 to obtain instructions which may be executed on the secondary device or to notify the server device 120 of a trigger event.

The systems and/or methods described herein may allow a user to automatically protect a user device and/or sensitive data contained on the user device. The systems and/or methods, may include a first user device that communicates with a second device (e,g. a second user device, a secondary device, etc.) via a local network. The first user device and/or second device may monitor state information associated with the first user device to determine whether the state information meets or exceeds a first threshold indicating a first trigger event. Upon a first trigger event, the first user device and/or second device may perform a first security operation and may continue to monitor state information associated with the first user device to determine whether the state information indicates that a second threshold has been reached, indicating that a second trigger event has occurred. Upon a second trigger event, the first user device and/or second device may perform a second security operation and may continue to monitor state information associated with the first user device to determine whether the state information indicates that a third threshold has been reached, indicating that a third trigger event has occurred. Upon a third trigger event, the first user device and/or second device may perform a third security operation and may continue to monitor state information associated with the first user device to determine whether the state information indicates that a fourth threshold has been reached, indicating that a fourth trigger event has occurred, requiring the performance of a fourth security operation by the first user device and/or second device.

In one embodiment, the state information includes the distance between the first user device and the second device, and the first trigger event corresponds to a threshold distance between the user device and the second device. The first security operation that results from the first trigger event is to send a notification to the user via the second device to alert the user of the fact that the user has exceeded the threshold distance from the first user device. The first security operation may also include providing a notification (e.g. an alert on the screen of the first user device) on the first user device. In response, the user may retrieve the first user device and cancel the notification on the first user device to prevent the second trigger event. The second trigger, event may arise from monitoring the amount of time from when then the notification is sent to the user until the user cancels the notification to determine that a second threshold has been met. (i.e. the second threshold is the second trigger event) when the amount of time exceeds a first time (e.g. 30 seconds, 1 minute, 5 minutes. etc.). When the user cancels the notification on the first user device, the time may not reach the first time. In response to the second trigger event, a second security operation may correspond to the first user device locking itself (i.e. executing instructions that cause the first user device to lock itself when the first time is reached). The first user device may continue to monitor the time from when the notification is sent until the user cancels the notification on the first user device until the time reaches a third threshold corresponding to a second time (e.g. more than the first time), indicating a third trigger event. In response to the third trigger event, the first user device may execute a third security operation, which may include a second notification. The second notification may include a loud ring, alarm and/or other types of notifications described herein. The second notification may help the user find the first user device and/or may cause a criminal to drop the first user device. The first user device may continue to monitor the time from when the notification is sent until the user cancels the notification on the first user device until the time reaches a fourth threshold corresponding to a third time (e.g. more than the first time and second time), indicating a fourth trigger event. In response to the fourth trigger event, the first user device may execute a fourth security operation, which may include, for instance, uploading the sensitive data to a server device, deleting the sensitive data, overwriting the sensitive data, etc.

The foregoing description provides illustration and description, but is not intended to be exhaustive or to limit the implementations to the precise form disclosed. Modifications and variations are possible in light of the above teachings or may be acquired from practice of the embodiments. For example, the systems and/or methods are described in a manner in which application server 120 communicates with user device 110 and/or other devices for explanatory purposes and need not be so limited. In another implementation, user device 110 and/or another device or any combination of these devices and application server 120 may receive, send and/or route communications between user device 110 and other devices or servers.

While a series of thresholds, trigger events and security operations have been described herein, the order and/or timing of the trigger events and security operations is not intended to be limited to those described herein and may be modified in other implementations. Security operations, thresholds, and trigger events may be determined by the user, of the user device and/or another device and may be easily changed based on logic that can be executed by one or more of the devices herein. Further, security operations may be performed in parallel, concurrently, substantially concurrently, and/or in a different order. There may be additional security operations, modified security operations, etc.

It will be apparent that systems and methods, as described above, may be implemented in many different forms of software, firmware, and hardware in the implementations illustrated in the figures. The actual software code or specialized control hardware used to implement these systems and methods is not limited to the example embodiments described herein. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components car groups thereof.

Even though particular combinations of features are recited in the claims and/or disclosed in the specification, these combinations are, not intended to limit the disclosure of the embodiments. In that, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method for protecting a user device or sensitive data contained on the user device, the method comprising:
providing a secondary device that communicates with the user device via a wireless connection;
monitoring state information of the riser device by the secondary device via the wireless connection;
determining, by the secondary device, the user device or both, that a first trigger event has occurred when the state information reaches a first threshold;
executing a first security operation, by the secondary device or the user device, to protect the user device or the sensitive data contained on the user device when the first trigger event occurs.

2. The method of claim 1, further including:
determining that a second trigger event has occurred when the state information readies a second threshold:
executing a second security operation, by the secondary device or the user device, to protect the user device or the sensitive data contained on the user device when the second trigger event occurs.

3. The method of claim 2, further including:
determining that a third trigger event has occurred when the state information reaches a third threshold;
executing a third security operation, by the secondary device or the user device, to protect the user device or the sensitive data contained on the user device when the third trigger event occurs.

4. The method of claim 3, further including:
determining that a fourth trigger event has occurred when the state information reaches a fourth threshold;
executing a fourth security operation, by the secondary device or the user device, to protect the user device or the sensitive data contained on the user device when the fourth trigger event occurs.

5. The method of claim 1, where the state information corresponds to:
a distance between the user device and the secondary device;
an existence of the wireless connection;
a location of the user device relative to a prohibited area;
an amount of time the user device has been in the same location;
a battery life of the user device;
an incorrect password has been entered into the user device;
an unsuccessful attempt to unlock the user device;
an unrecognized device attempts to access the user device; or
a combination of the foregoing.

6. The method of claim 5, where the distance between the user device and the secondary device is determined by geofencing.

7. The method of claim 5, where the distance between the user device and the secondary device is determined by using beacons.

8. The method of claim 1, where the wireless connection corresponds to a WiFi connection or a Bluetooth connection.

9. The method of claim 1, where the first security operation corresponds to one or more of:
sending a notification to a user of the user device by the secondary device,
locking the user device, or
communicating, the trigger event to a server device via a network by the secondary device or the user device.

10. The method of claim 9, where the notification corresponds to at least one of
a tactile notification,
an audible notification, or
a visual notification.

11. The method of claim 2, where the state information includes an amount of time from when a notification was sent to the user by the secondary device and the second threshold corresponds to a first time from when the notification was sent to the user by the secondary device.

12. The method of claim 11, where the first threshold corresponds to a distance between the user device and the secondary device.

13. The method of claim 2, where the second security operation corresponds to one or more of:
locking the user device,
prioritizing the sensitive data contained on for user device,
uploading the sensitive data contained on the user device to a server device via a network,
encrypting the sensitive data,
deleting the sensitive data, or
overwriting the sensitive data.

14. The method of claim 1 further including:
monitoring state information of the user device by a server device that is connected to the user device via a network;
determining, by the server device, that the first trigger event has occurred when the state information reaches the first threshold;
executing a server security operation, by the server device, to protect the user device or the sensitive data contained on the user device.

15. The method of claim 14 where the server security operation corresponds to communicating with the user device to prompt the user device to execute instructions to upload the sensitive data to the server device via the network.

16. The method of claim 3, where the state information includes an amount of time from when a notification was sent to the user by the secondary device, the first threshold corresponds to a distance between the user device and the secondary device, the second threshold corresponds to a first time threshold determined from when the notification was sent to the user by the secondary device, and the third threshold corresponds to a second time threshold determined from when the notification was sent to the user by the secondary device, the second time threshold being greater than the first time threshold.

17. The method of claim 3, where the third security operation corresponds to one or more of:
prioritizing the sensitive data contained on the user device.
uploading, the sensitive data contained on the user device to a server device via a network,
encrypting the sensitive data,
deleting the sensitive data, or
overwriting the sensitive data.

18. A method for protecting a user device or sensitive data contained on the user device, the method comprising:
providing a secondary device that communicates with the user device via a wireless connection;
determining a distance between the secondary device and the user device;
monitoring the distance between the user device and the secondary device;
determining, by the secondary device, that a first trigger event has occurred when the distance reaches a first threshold;
providing, via the secondary device, a notification to a user of the user device to protect the user device or the sensitive data contained on the user device.

19. The method of claim 18, further including:
determining that a second trigger event has occurred when the user has not responded to the notification or has not dismissed the notification;
locking the user device to protect the user device or the sensitive data contained on the user device.

20. The method of claim 18 further including:
providing a server device that communicates with the user device and the secondary device via a network to determine a first location of the user device and a second location of the secondary device;
comparing the first location to the second location to determine the distance between the user device and the secondary device;
communicating by the server device via the network to the user device to lock the user device.

21. The method of claim 18, where the distance is determined by the secondary device.

22. The method of claim 21, where the secondary device determines the distance using beacon technology.

23. A secondary device for determining whether a distance between the secondary device and a user device has exceeded a threshold, the secondary device comprising:
a communication interface that permits a wireless connection to be established with the user device,
a processor that executes instructions to monitor the distance and to determine whether the distance has exceeded the threshold,
a user interface that provides a notification to a user of the user device when the distance exceeds the threshold, and
a power source.

24. The secondary device of claim 23 further including a memory that includes the instructions executed by the processor.

25. The secondary device of claim 21 where the instructions are provided to the processor by a server device via a network.

26. The secondary device of claim 23, where the notification is one or more of:
an audible notification,
a tactile notification, or
a visual notification.

27. The secondary device of claim 23, where the device is made in the form of:
a bracelet,
a watchband,
a necklace, or
another wearable article.
